(19) United States
(12) Patent Application Publication
(10) Pub. No.: US 2007/0286442 A1
(43) Pub. Date: Dec. 13, 2007

(54) Method of manufacturing a custom shaped hearing instrument

(75) Inventors: Hans Hessel, Benglen (CH); Erdal Karamuk, Meilen (CH); Bruno Gabathuler, Staefa (CH); Andre Lucien Ochsenbein, Wolfhausen (CH)

Correspondence Address: PEARNE & GORDON LLP, 1801 EAST 9TH STREET, SUITE 1200, CLEVELAND, OH, 44114-3108, US

(73) Assignee: Phonak AG, Staefa (CH)

(21) Appl. No.: 11/452,056

(22) Filed: Jun. 13, 2006

(51) Int. Cl. H04R 29/00

(52) U.S. Cl. 381/322; 381/60; 381/312

(57) ABSTRACT

The present invention provides a method of manufacturing custom shaped hearing instruments by arranging virtually all components of said hearing instrument within the shape of the shell to define the final locations of said components. Subsequently, support elements as support structure within the shell according the final locations of the components will be generated digitally, for manufacturing said shell using a digital printing technique considering the digitally processed data from said antecedent steps. Then, connecting the components together with any necessary wiring, placing the components into the manufactured shell at its designated locations into the respective support elements, placing and attaching a cover plate onto said opening of said shell, thereby clamping said components between the cover plate and the shell or the support elements respectively. By applying the present method, there is advantageously no need of designing and using a faceplate which comprises a lot of the components of the hearing instrument.

### TECHNICAL FIELD

This invention relates generally to the manufacturing of custom shaped hearing instruments, hearing devices or hearing aids and particularly to in-the-ear (ITE) hearing instruments.

This invention further relates generally to a custom shaped hearing instrument and particularly to an in-the-ear (ITE) hearing instrument.

### BACKGROUND OF THE INVENTION

In state-of-the-art custom shaped hearing instruments, the components, such as battery carrier, microphone and user controls are individually arranged in the ear shell of said hearing instrument. The necessary support structures to hold those components in place and the shape of the ear shell are generated by modeling software processing the individual data provided for the manufacturing process. The resulting ear shell commonly built up of two parts, a first part to be placed at least partially in the ear canal and comprising all the components, and a second part built as cover plate facing to the outside of the ear. This second part will commonly be secured on top of the first part, thereby covering the components and giving an optically and cosmetically smooth appearance.

Particularly with respect to ITE hearing devices, the components are commonly arranged within an earshell that is custom made to fit into the ear of the user of the ITE hearing device. The ear shell regularly will be made on the base of an individual impression made of the ear of the user. The components comprise of battery holder, contact elements, programming interfaces, microphone, amplifier, signal processing unit, switches and other user controls and are commonly built as a cluster on a plastic plate that is commonly called a faceplate. The faceplate will be trimmed to match the geometry of the ear shell. After inserting and fixing a speaker, commonly named receiver in the field of hearing aid technology, into the ear shell, the faceplate will be bonded to the ear shell with an adhesive.

To build custom shaped ITE's with individual components, a technology named “built from scratch” is commonly used in the industry. It consist of taking a flat faceplate of a standardized outer shape and size containing only battery contacts and battery door axis. The positions of microphone and additional control elements will be defined by drilling bores or openings at predefined, specific locations. Those components will then be mounted on the faceplate by means of adhesive bonding. All those tasks have to be performed by experienced ITE manufacturers in order to achieve the smallest possible volume shape occupied by those components to fit into a given custom shell, specified by the ear geometry of an individual person to wear such an ITE. Thus, this method is very time consuming and therefore very costly. Another disadvantage lies in the fact that the electronic components must be wired during the manufacturing process, which increases the risk of failure and complicates or disables any possibility of standardized testing.

Alternatively to the above described method, the components may be arranged in modules that fit into an adapter plate. The module or modules are usually removably attached to the adapter plate by means of fasteners such as screws or clips or the like. The adaptor plate is then glued to the customized earshell and will then be trimmed to match the shape of the customized earshell. ITE's made by this method are often referred to as semi-modular, because the receiver is normally attached to the shell by means of an output tube which is glued to the shell at its tip. A problem now occurs if the module has to be unfastened or detached from the adaptor, as the wiring between the module and the receiver is still connected through the earshell. Furthermore, the smallest possible size of the module dictates the minimal size of shape of the customized earshell, so that this method may not be applicable in case of small or extremely wounded ear canals.

In U.S. Pat. No. 6,493,454 B1 a hearing aid is disclosed including a faceplate and an adaptor plate matching the underside of the faceplate. Those two parts are attached to each other by means of fasteners such as clips or screws. The faceplate and the adaptor plate are cut and trimmed to the custom shape of the earshell to seamlessly match the outer shape of the earshell. Only the adapter plate is glued to the earshell, whereby the faceplate is attached to the adapter plate as described above. Thus, the known pre-molded faceplate to be cut and trimmed to its final matching shape is described with all disadvantages already mentioned above.

In EP 1 341 397 a housing for an ITE hearing device is disclosed comprising two half-shells as sections to be coupled together to form the final earshell. The seam of the two coupled sections extends between both ends of the earshell and is placed in such a way to minimize its visibility from outside when inserted in the ear. The inside of the sections comprises supporting structures for receiving electronic modules and receiver. The sections are made by use of a digital printing technique. Such a concept doesn't allow any individual arrangement of components within the earshell due to the standardized supporting structures.

US 2003/0152242 discloses a monolithic housing for an ITE device. The faceplate is an integral part of the monolithic unit, thus emphasizing the benefit of a rapid modeling and prototyping of a hearing device housing. An opening in the faceplate will be created during the production process of the monolithic housing for receiving a module comprising electronic components for the hearing device. Thus, only a support structure for a predefined positioning of the module containing all necessary components is provided.

The miniaturization of all those known hearing devices is restricted by the pre-defined and standardized support structures for the modules and/or components to be arranged within the earshell. Due to this restriction, a minimal required volume and shape is predefined and may not be altered, thus disabling the use of such hearing devices in case of very small or curved ear shapes of individual persons.

### SUMMARY OF THE INVENTION

It is an object of the present invention to provide an improved method for manufacturing ITE hearing devices or instruments with custom shaped earshell.

The present invention provides a method of manufacturing custom shaped hearing instruments comprising the steps of:

recording the data of the individual shape of the ear and/or ear canal of the person to wear the hearing instrument,

designing digitally the shape of a shell for said hearing instrument by using said recorded data, the shell being a hollow shell having at least one opening at its distal end,

arranging virtually all components, such as battery module, microphone(s), electronic module(s) and control(s), of said hearing instrument within said shape of the shell to define the final locations of said components,

generating digitally support elements as support structure within said shell according to said final locations of said components, said support structure comprising openings or cuts accessible from the distal opening of said shell,

manufacturing said shell using a digital printing technique considering the digitally processed data from said antecedent steps,

connecting said components together with any necessary wiring,

placing said components into said manufactured shell at its designated locations into the respective support elements, by carrying the wiring through said openings or cuts of the support elements,

placing and attaching a cover plate onto said opening of said shell, thereby clamping said components between the cover plate and the shell or the support elements respectively.

By applying the inventive method, there is advantageously no need of designing and using a faceplate which comprises a lot of the components of the hearing instrument. The faceplate is replaced by an assembly of components which are wired together and placed directly within the individually shaped shell at individually predefined positions. By individually defining the positions of all the components, there is practical no limitation in adapting the outer shape of the shell to fit any individual shape of the ear or ear canal of the user of the hearing instrument. According to the individually shaped shell, the components may be arranged individually to fit into such a shell. Furthermore, individual needs and individual cosmetic principles may be taken into account in the arranging process of the components, especially for the components directed to the outside of the hearing instrument, such as switches, user controls or connecting components.

In an embodiment of the method according the present invention, the method further comprises the step of pre-assembling the wiring of said components. All components may advantageously be pre-assembled by a pre-wiring of the components. In a special embodiment, the components may be wired to a battery module or battery carrier that is made of injection molded plastic and containing a hinge-pin and battery as well as programming contacts. The length of the wires is the only restriction of the ability to arrange the components within the shell. The battery module or battery carrier comprises as well a battery door, i.e. made of injection molded plastic.

In a further embodiment of the method according the present invention the components are chosen out of a range of standard components according the individual needs and/or prerequisites of the person to wear the hearing instrument. Thus, the technician may choose only the necessary components to be included within the hearing instrument and thus the wiring may be limited to the appropriate components.

In a further embodiment, the method comprises as first step defining the location of a battery carrier taking into account the geometry of said battery carrier and the geometry of the individual shape of the ear or ear canal. As the battery carrier is regularly the biggest component to be placed into the shell and has to be accessible from the outside, to replace the battery, there is less freedom in choosing an optimal location. Most of the other components may be positioned within the shell with a greater freedom.

In a further embodiment of the present method, a receiver is mounted into said shell by using an elastomeric tube and suspension. The receiver will be mounted as one of the first components into the shell and hold by use of an elastomeric tube and suspension. This will minimize any acoustical interference directed through the shell to the receiver.

In a further embodiment of the present method, the cover plate is attached to the shell by means of adhesive, mechanical interlocking elements, such as snap fits, or separate fixing means such as screws. The first means provides a stable, compact and leak-proof connection between the cover plate and the shell. The mechanical interlocking elements allow a quick and reliable connection of the cover plate, which is secured from unintentional or independent loosening. Furthermore, the use of fixing means like screws will provide a reliable connection that resist even heavy load, but remains detachable in case of maintenance or replacement of the components.

It is a further object of the present invention to provide an ITE hearing device or hearing instrument with a custom shaped earshell with only little restrictions with respect to the size and shape of the earshell due to the necessary components and/or modules to be arranged within the earshell.

The present invention thus provides a hearing instrument comprising

a custom shaped shell, the shell having at one end an opening,

one or more components to be arranged within and/or at the shell, the components being selectively connected to each other by means of wiring and comprising at least of

a battery carrier to be inserted into said shell comprising programming contacts,

an electronic module,

a microphone,

control elements for the individual control or setting of values of the electronic module; furthermore

a cover plate to be connected to the shell to close said opening, the outer surface of the cover plate being individually shaped and having at least one aperture,

wherein the shell comprising individually arranged support structures for positioning and holding each of said components in a predefined position within the shell.

In an embodiment of the present hearing instrument, the material of said cover plate and said shell are different from each other. That means that they may be of different material as such or may be of different color and/or surface smoothness.

### DESCRIPTION OF THE DRAWINGS

For purpose of facilitating and understanding of the invention, an exemplary embodiment thereof is illustrated in the accompanying drawings to be considered in connection with the following description. Thus the invention may be readily understood and appreciated, but not limited to this embodiment.

FIG. 1 is a view of an embodiment of an assembled hearing instrument according the present invention;

FIG. 2 is a view onto the empty shell of the hearing instrument according to FIG. 1;

FIG. 3 is a view onto pre-assembled components to be mounted into the shell according to FIG. 2;

FIG. 4 is a view onto the shell according to FIG. 2 with first components already inserted or positioned respectively;

FIG. 5 is a view onto the shell according to FIG. 3 with a battery module inserted into its predetermined location;

FIG. 6 is a view onto the shell according to FIG. 4 with a cover plate mounted onto the shell;

FIG. 7 is a view onto the outside surface of the cover plate according to FIG. 6; and

FIG. 8 is a view onto the inner surface of the cover plate according to FIG. 6.

### DESCRIPTION OF A PREFFERED EMBODIMENT

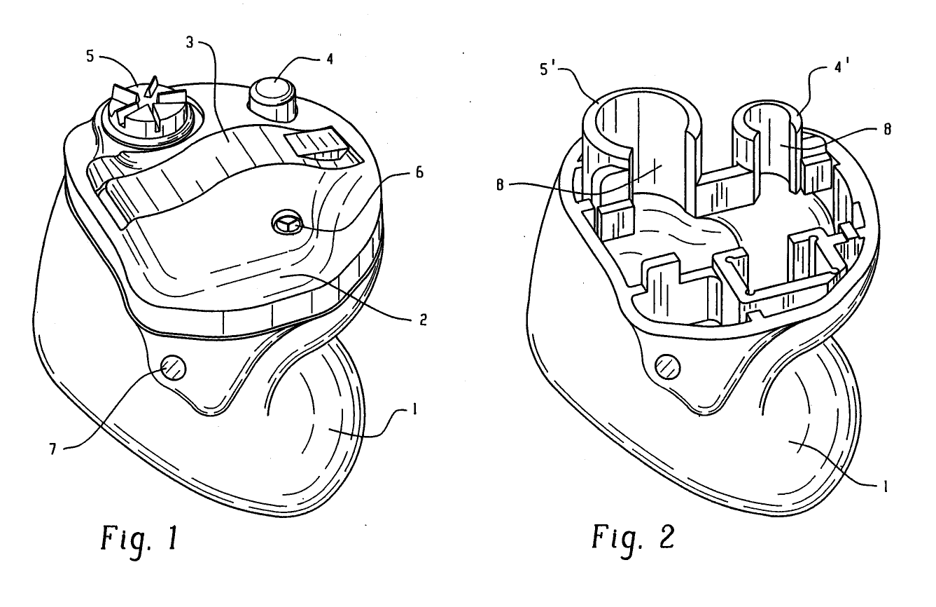

Referring to FIG. 1, an embodiment of a hearing instrument according the present invention is shown in its assembled state.

The shell 1 of the hearing instrument, e.g. an ITE custom built hearing instrument, is closed by a cover plate 2. The cover plate 2 comprises some apertures or openings, that are filled with a battery door 3, a push-button 4 and a volume control 5 to be handled manually by the user of the hearing instrument. Furthermore, a microphone opening 6 is covered by a microphone cover. The shell 1 comprises as well openings, like a vent 7, for conducting the ear canal with the exterior.

In known hearing instruments, said visible components are usually attached directly to the cover plate 2, called the faceplate. A big disadvantage results from transferring all tensile and compressive forces to the shell by said faceplate. Those forces will be produced for instance by opening and closing of the battery door, by activating a push-button or a volume control by the user of the hearing instrument. Thus, the cover plate must be provided with a sufficient support structure or wall thickness that increases the volume and size of such a faceplate.

FIG. 2 now depicts the view into the empty, open shell of the hearing instrument of FIG. 1, e.g. with cover plate 2 and all components removed from the shell. The support structures for those components are now fully visible, i.e. the tube-like support elements 5′ and 4′ for receiving the volume control 5 and the push-button 4 respectively. The support elements 5′ and 4′ have slots 8 arranged at its sidewalls for inserting the wires of the components when arranging the components into their proper support elements.

The exact position of those support elements 4′, 5′ has been digitally generated based on the virtual arrangement of all components within a computerized model of the shell of the hearing instrument. Such a model can be generated after having recorded the data of the individual shape of the ear or the ear canal of the person determined to wear the hearing instrument. Such a recording may be done either by making impressions of the ear canal or by using optical or acoustical scanning processes.

Those data may be processed by a computer for digitally designing the shape of the individual shell of the hearing instrument and thus receiving a computerized model of the shell.

The virtual arrangement of all necessary components for the hearing instruments may be done by a specialist using a computer with stored geometrical data of those components. By virtually arranging all those components within the digital shape of the shell, the final location of all those components may be found, taking into account additional needs or parameters for some or any of the components.

Thus, the final shape of the inside of the shell 1 comprising all support elements may be digitally stored and used for manufacturing, i.e. by using a digital printing technique.

It can easily be seen that all tensile and compressive forces produced by activating the respective components will be transferred directly through the sidewalls of the support elements into the wall of the shell 1. Thus, cover plate 2 will be free of such forces or strength from the functional components of the hearing instrument. The wall thickness of the cover plate 2 may thus be smaller with respect to known faceplates and there is no need for additional support structure on the cover plate 2.

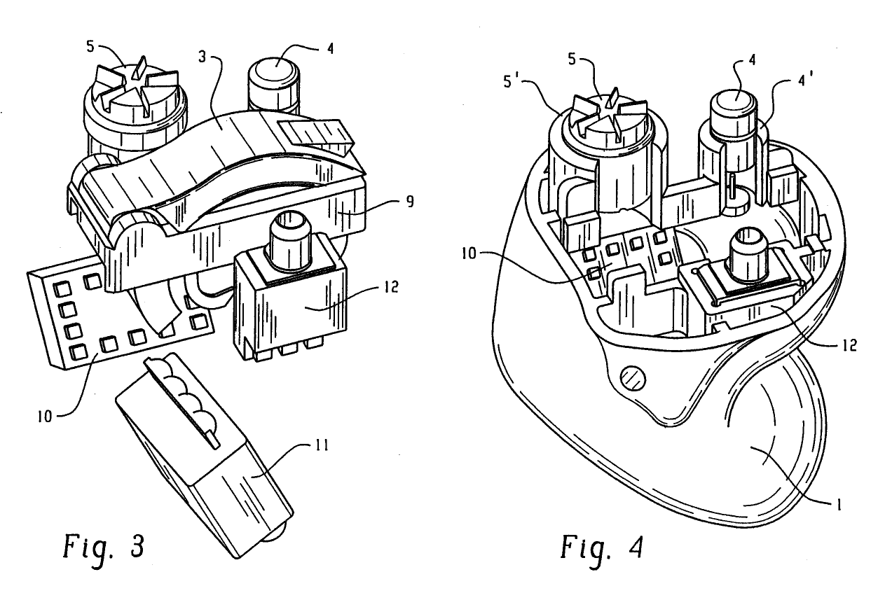

FIG. 3 depicts the view onto the pre-assembled components of the hearing instrument, such as push-botton 4, volume control 5 an electronic module 10, a receiver 11 and a microphone 12. Those components are electrically connected to a battery carrier 9 with electric wiring (not shown on FIG. 3 for a better overview). Thus, all those components may be practically unrestricted positioned with respect to the battery carrier 9, only limited by the length of their respective wires.

The battery carrier 9 receives as well a battery door 3. The hinge of the battery door 3 is provided at the battery carrier 9 to receive the tensile forces activated by the user by opening or closing the battery door 3. The series of FIGS. 4 to 6 now show the manufacturing of the hearing instrument, e.g. the assembling of the components of the hearing instrument.

In FIG. 4, most of the components, such as the push-button 4, the volume control 5, the electronic module 10 and the microphone 12 are placed within their proper support elements of the shell 1. As a first step, the receiver 11 has been mounted using an elastomeric tube and suspension into the lower end of the shell 1. The wires (not shown for a better overview) of the components are led through the slots in the support elements and are still connected to the battery carrier 9 that is still arranged outside shell 1.

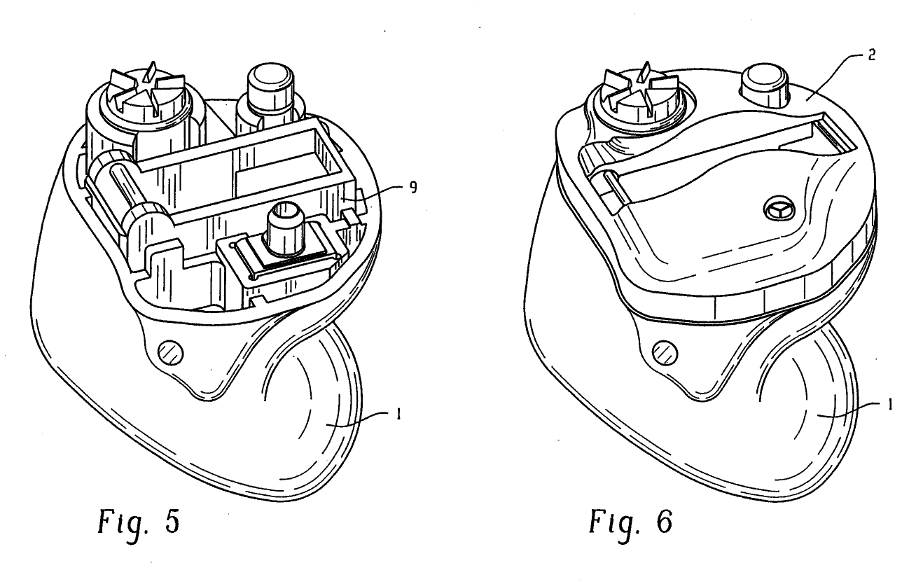

In a next step, as shown in FIG. 5, the battery carrier 9 has been placed as well into its proper support element within the shell 1.

The cover plate 2 may now be attached to the shell 1 to close its opening. Cover plate 2 may be fixed to shell 1 by means of adhesive. That means that the cover plate 2 is directly glued or welded to the rim of the shell 1. Otherwise, the cover plate 2 may be snapped onto the shell 2 by means of mechanically interlocking tongues by pressing cover plate 2 onto the rim of shell 1 until the tongues, either arranges at cover plate 2 or shell 1 or both, snap into their respective receiving openings.

Furthermore, cover plate 2 may be attached to shell 1 by means of screws or the like, thereby achieving a strong but easy detachable connection between cover plate 2 and shell 1.

The cover plate 2 not only serves as a cover for the opening of shell 1 but also as holding or clamping mean for the components arranged in their proper support elements within shell 1. Thus, the components do not need to be fixed by any other means or fixation elements.

Finally, the battery door 3 may be inserted into its position within the battery carrier 9 and the hearing instrument is ready for use, as depicted in FIG. 1.

The individual placement of the components within the shell 1 of the hearing instrument allows the building of even smaller hearing instruments compared to the known hearing devices with a faceplate. Individually shaped hearing devices will thus be available even for persons having small or heavily convoluted ear canals.

The time consuming and costly step of cutting and grinding a faceplate may advantageously be omitted. Thus, the overall production time for such a hearing instrument may be reduced.

The manufacturing costs may as well be reduced, as the production of the faceplate is replaced by an individually configurable assembly of components wired to the battery carrier.

Furthermore, the mechanical stability of hearing instruments may be enhanced as the components are mechanically decoupled and supported directly to the shell of the hearing instrument.

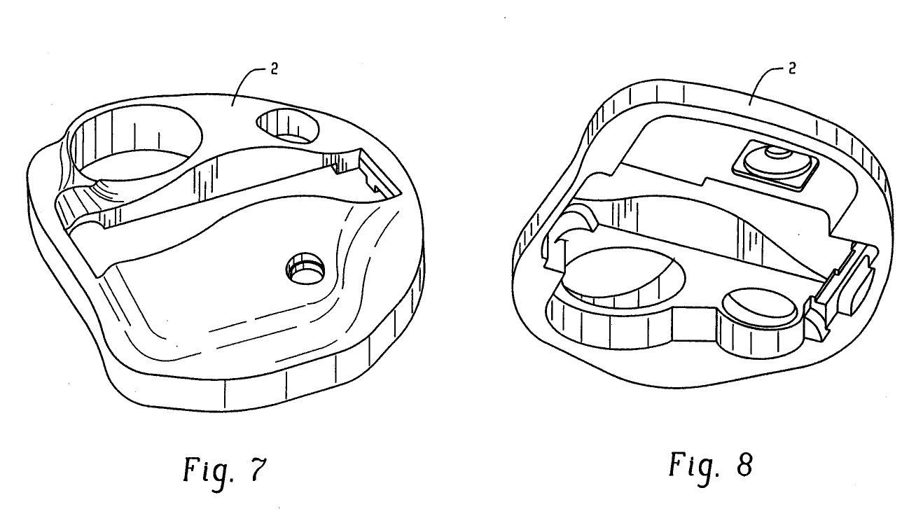

The top view and bottom view onto the cover plate 2 is depicted in FIGS. 7 and 8. Cover plate 2 only has to be shaped according the opening of the shell 1 of the hearing instrument and has to receive openings for the components according the location data of those components. There is no need to provide additional strength elements or a thick wall for receiving forces from the components, as the components will not be directly supported by the cover plate 2.

It will be clear to one skilled in the art that other applications may be substituted for those set forth herein without departing from the spirit and scope of the present invention.

What is claimed is:

1. A method of manufacturing custom shaped hearing instruments comprising the steps of:
recording the data of the individual shape of the ear and/or ear canal of the person to wear the hearing instrument,
designing digitally the shape of a shell for said hearing instrument by using said recorded data, the shell being a hollow shell having at least one opening at its distal end,
arranging virtually all components, such as battery module, microphone(s), electronic module(s) and control(s), of said hearing instrument within said shape of the shell to define the final locations of said components,
generating digitally support elements as support structure within said shell according to said final locations of said components, said support structure comprising openings or cuts accessible from the distal opening of said shell,
manufacturing said shell using a digital printing technique considering the digitally processed data from said antecedent steps,
connecting said components together with any necessary wiring,
placing said components into said manufactured shell at its designated locations into the respective support elements, by carrying the wiring through said openings or cuts of the support elements,
placing and attaching a cover plate onto said opening of said shell, thereby clamping said components between the cover plate and the shell or the support elements respectively.

2. Method according to claim 1 further comprising the step of pre-assembling the wiring of said components.

3. Method according to claim 2 wherein the components are chosen out of a range of standard components according to the individual needs and/or prerequisites of the person to wear the hearing instrument.

4. Method according to claim 1 wherein as a first step, the location of a battery carrier will be defined taking into account the geometry of said battery carrier and the geometry of the individual shape of the ear or ear canal.

5. Method according to claim 1 wherein a receiver is mounted into said shell by using an elastomeric tube and suspension.

6. Method according to claim 1 wherein the cover plate is attached to said shell by means of adhesive, mechanical interlocking elements, such as snap fits, or separate fixing means such as screws.

7. Hearing instrument comprising
a custom shaped shell (1), the shell (1) having at one end an opening,
one or more components to be arranged within and/or at the shell (1), the components being selectively connected to each other by means of wiring and comprising at least of
a battery carrier (9) to be inserted into said shell (1) comprising programming contacts,
an electronic module (10),
a microphone (12),
control elements (4;5) for the individual control or setting of values of the electronic module; furthermore
a cover plate (2) to be connected to the shell (1) to close said opening, the outer surface of the cover plate (2) being individually shaped and having at least one aperture,
wherein the shell (1) comprising individually arranged support structures (4′;5′) for positioning and holding each of said components (4;5;10;11;12) in a predefined position within the shell (1).

8. Hearing instrument according to claim 7 wherein the materials of said cover plate (4) and said shell (1) are different from each other.
